(19) United States
(12) Patent Application Publication
(10) Pub. No.: US 2012/0274843 A1
(43) Pub. Date: Nov. 1, 2012

(54) Image Capturing Device and Assembly Method Thereof

(75) Inventor: Wen-Po Chang, Zhubei City (TW)

(73) Assignee: ALTEK CORPORATION, Hsinchu (TW)

(21) Appl. No.: 13/179,236

(22) Filed: Jul. 8, 2011

(30) Foreign Application Priority Data
Apr. 27, 2011 (TW) 100114589

(51) Int. Cl. H04N 5/225; B23P 17/00; B23P 11/00

(52) U.S. Cl. 348/374; 29/428; 29/525.11; 348/E05.024

(57) ABSTRACT

An image capturing device and its assembly method are disclosed. The image capturing device comprises a main board, a metal plate and a sensing unit. The main board comprises a first hollowed block. The metal plate comprises a second hollowed block corresponded to the first hollowed block and is disposed at one side of the main board. The sensing unit is disposed at the other side of the main board. The metal plate is parallel to the sensing element. The first hollowed block and the second hollowed block are filled by a fastening material. In addition, the image plane of the sensing unit is perpendicular to the optical axis of the lens set. Therefore, image quality is improved.

### BACKGROUND OF THE INVENTION

1. Field of the Invention

The present invention relates to an image capturing device and an assembly method thereof, and more particularly to an image capturing device and an assembly method thereof capable of aligning a lens set and a photosensitive element.

2. Description of the Related Art

In the manner of calibrating the level of a conventional image sensing element, the reflection of a light beam irradiated from a lens is detected to check whether or not the image sensing element is vertical to the normal-line of the lens. Upon the detecting result, the operator continues adjusting the inclination of the circuit board carrying the image sensing element until the image sensing element is vertical to the normal-line of the lens, and the calibrated image sensing element is arranged a flexible printed circuit board for electric connection with the external circuit.

The conventional calibration manner is time and labor consuming and needs an extra flexible printed circuit board also increase cost. Therefore, for the purpose of cost down, the image sensing element and external circuit are designed to directly arrange on one printed circuit board, but the printed circuit board will be bent after calibration. Bending the whole circuit board may cause deformation, and the stress generated from the deformation may pull and drag the soldering between the image sensing element and the circuit board to crack these soldering. Consequently, the image sensing element may not receive control signals and may not transmit image signals.

Designing an image capturing device and its assembly method capable of aligning the lens set and the photosensitive element has become an important issue in the market application so as to satisfy the demands.

### SUMMARY OF THE INVENTION

In view of the shortcomings of the prior art, the inventor(s) of the present invention based on years of experience in the related industry to conduct extensive researches and experiments, and finally developed an image capturing device and its assembly method as a principle objective to overcome the problem of complicated alignment between a photosensitive element and a lens set in the prior art.

To achieve the foregoing objective, an image capturing device is provided and comprises a main board, a metal plate and a photosensitive element. The main board comprises a first hollowed block. The metal plate comprises a second hollowed block corresponding to the first hollowed block and is disposed to one side of the main board. The photosensitive element is disposed to the other side of the main board. The metal plate and the photosensitive element are parallel to each other. The first hollowed block and the second hollowed block are filled with a fastening material.

The main board comprises at least one first tooling hole. The metal plate further comprises at least a second tooling hole corresponding to each first tooling hole. Each first tooling hole and the second tooling hole corresponding to each first tooling hole are positioned by a tooling component.

The main board further comprises at least a first screw hole. The metal plate further comprises at least a second screw hole corresponding to each first screw hole.

The invention further comprises a lens set. The lens set and the photosensitive element are disposed on the side of the main board. An image sensing face of the photosensitive element is vertical to an optical axis of the lens set.

According to an objective of the invention, an assembly method for an image capturing device is provided and comprising the following steps: providing a main board comprising a first hollowed block; disposing a metal plate at one side of the main board, the metal plate comprising a second hollowed block corresponding to the first hollowed block; disposing a photosensitive element at the other side of the main board; regulating the main board to keep the metal plate parallel with the photosensitive element; and placing a fastening material in the first hollowed block and the second hollowed block.

The method further comprises the following step: screwing at least a first screw hole of the main board and at least a second screw hole of the metal plate corresponding to each first screw hole through at least a screw component.

The method further comprises the following step: disposing a lens set at a side of the main board, wherein the lens set and the photosensitive element are on the same side and an image sensing face of the photosensitive element is vertical to an optical axis of the lens set.

According to an objective of the invention, an image capturing device is further provided and comprises a main board, a metal plate and a photosensitive element. The main board comprises at least a first tooling hole. The metal plate comprises at least a second tooling hole corresponding to each first tooling hole and is disposed to one side of the main board. The photosensitive element is disposed to the other side of the main board. The metal board and the photosensitive element are parallel to each other. Each first tooling hole and the second tooling hole corresponding to each first tooling hole are positioned by a tooling component.

The main board further comprises a first hollowed block. The metal plate further comprises a second hollowed block corresponding to the first hollowed block. The first hollowed block and the second hollowed block are filled with a fastening material.

The invention further comprises a lens set. The lens set and the photosensitive element are disposed on the same side of the main board. An image sensing face of the photosensitive element is vertical to the optical axis of the lens set.

The fastening material comprises an UV glue. The image capturing device and its assembly method of the invention can have one or more advantages as the following.
(1) The image capturing device and its assembly method can fasten the relative relationship among the sensing element, the main board and the metal plate through the UV glue after positioning them through jigs. The complicated process for alignment between the image sensing element and the lens set can be further reduced.
(2) The image capturing device and its assembly method allow the image sensing face of the photosensitive element to be vertical to the optical axis of the lens set to further improve the quality of captured images.

### BRIEF DESCRIPTION OF THE DRAWINGS

FIG. 1 is a first schematic diagram of an image capturing device in accordance with an embodiment of the invention;

FIG. 2 is a first schematic diagram of a portion structure of an image capturing device in accordance with an embodiment of the invention;

FIG. 3 is a second schematic diagram of a portion structure of an image capturing device in accordance with an embodiment of the invention;

FIG. 4 is a second schematic diagram of a portion structure of an image capturing device in accordance with an embodiment of the invention;

FIG. 5 is a schematic diagram of an electronic device having image capturing function in accordance with an embodiment of the invention;

FIG. 6 is a flowchart of an assembly method for image capturing device in accordance with the invention.

### DETAILED DESCRIPTION OF THE PREFERRED EMBODIMENTS

The foregoing and other technical characteristics of the present invention will become apparent with the detailed description of the preferred embodiments and the illustration of the related drawings.

An image capturing device of the invention can be a portable electronic apparatus having image capturing function such as a digital camera, a camera phone, a Smartphone or a digital video camera. To understand technical features of the invention, the following example takes, but not limited to, the camera phone as an embodiment.

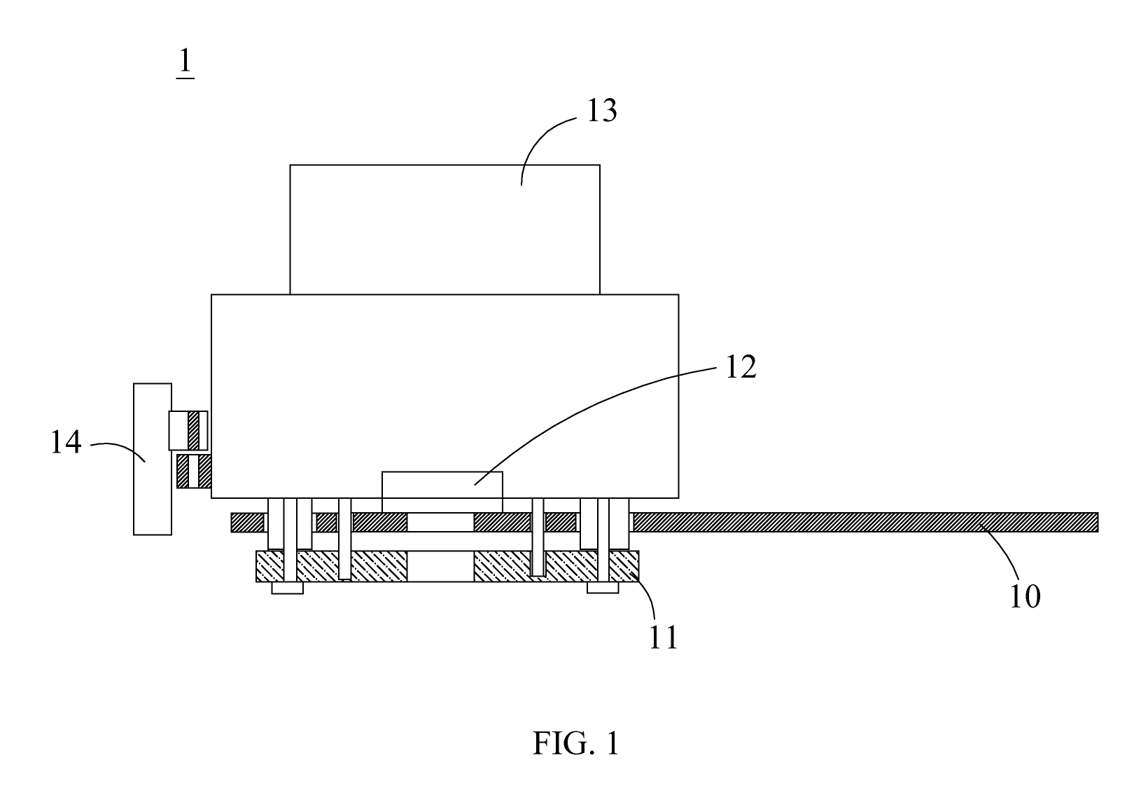

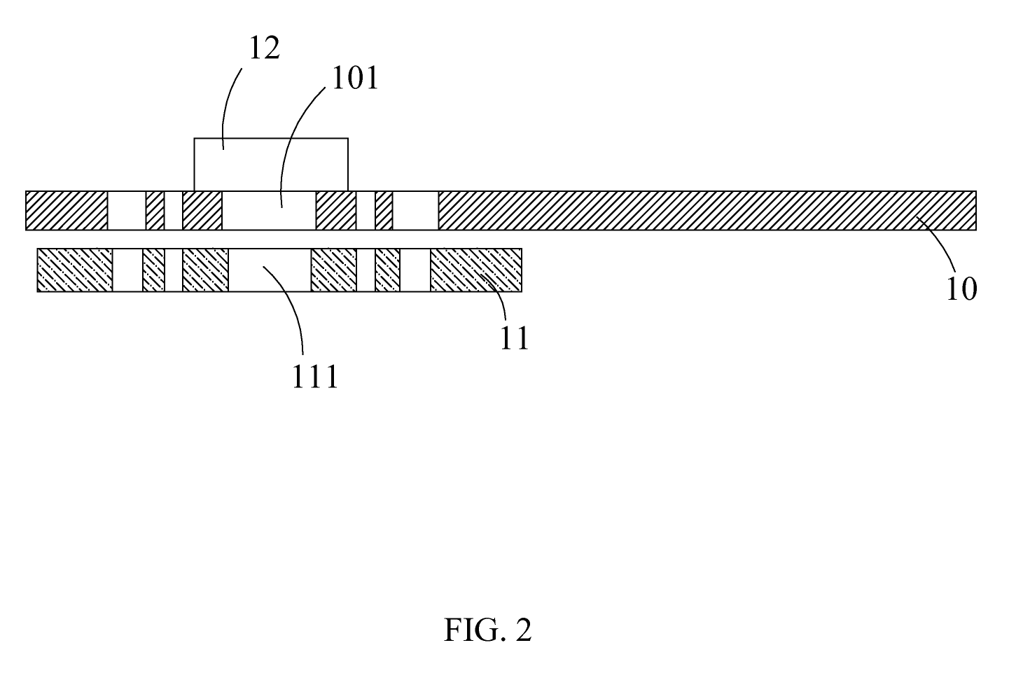

With reference to FIG. 1 for a first schematic diagram of an image capturing device in accordance with an embodiment of the invention is depicted. The image capturing device 1 of the invention comprises a main board 10, a metal plate 11, a photosensitive element 12, a lens set 13 and a frame 14. With reference to FIG. 2 for a first schematic diagram of a portion structure of an image capturing device in accordance with an embodiment of the invention is depicted. The main board 10 comprises a first hollowed block 101, and the main board 10 can be a printed circuit board (PCB). The metal plate 11 can be disposed to a side of the main board 10 and comprises a second hollowed block 111 corresponding to the first hollowed block 101. In the embodiment, the metal plate 11 can be disposed under the main board 10. The position of the second hollowed block 111 of the metal plate 11 can correspond to the position of the first hollowed block 101. Further, the photosensitive element 12 can be disposed to another side of the main board 10 corresponding to the metal plate 11. The photosensitive element can be a complementary metal-oxide-semiconductor (CMOS) or a charge-coupled-device (CCD).

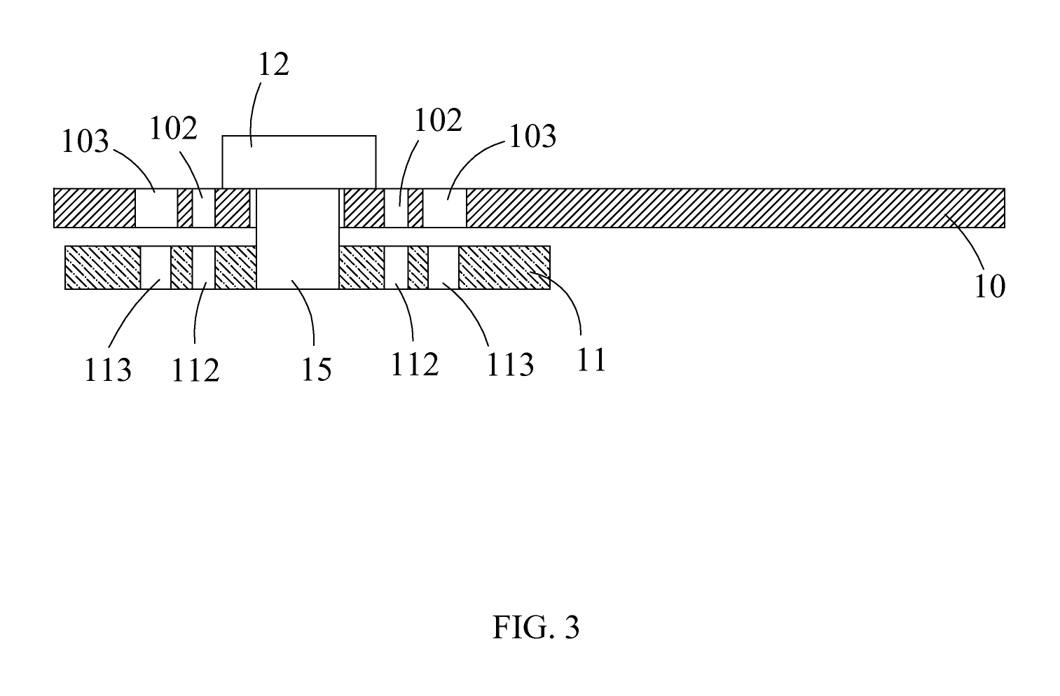

With reference to FIG. 3 for a second schematic diagram of a portion structure of an image capturing device in accordance with an embodiment of the invention is depicted. The image capturing device 1 of the invention can keep the metal plate 11 parallel with the photosensitive element 12 by regulating the inclination of the main board 10. Next, a fastening material 15 is placed in the first hollowed block 101 and the second hollowed block 111. Accordingly, the photosensitive element 12 and the metal plate 11 that are aligned are fastened to two sides of the main board 10 in parallel. In the embodiment, the fastening material 15 is, but not limited to, preferably an UV glue while in actual implementation.

The main board 10 of the image capturing device 1 of the invention comprises at least one first tooling hole. The metal plate 11 can include a second tooling hole corresponding to the first tooling hole. In the embodiment, the main board 10 can include two first tooling holes 102. The metal plate 11 can include two second tooling holes 112. Further, the main board 10 can comprise at least one screw hole. The metal plate 11 can comprise a second screw hole corresponding to the first screw hole. In the embodiment, the main board 10 can comprise two first screw holes 103. The metal plate 11 can comprise two second screw holes 113. It should be noted that numbers of the tooling hole and the screw hole are not limited to the foregoing manner while in actual implementation.

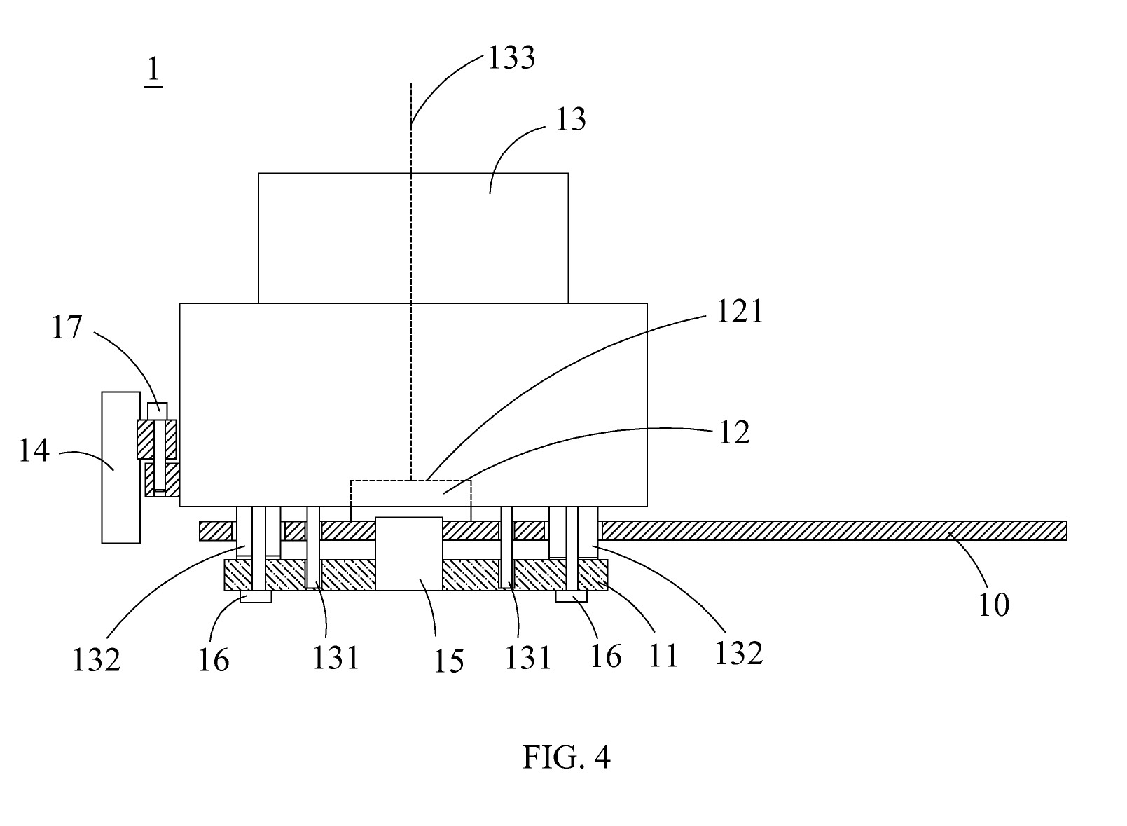

With reference to FIG. 4 for a second schematic diagram of a portion structure of an image capturing device in accordance with an embodiment of the invention is depicted. In the embodiment, the lens set 13 of the image capturing device 1 and the photosensitive element 12 can be disposed on the same side of the main board 10. The lens set has two first protrusion portions 131 and two second protrusion portions 132. The two first protrusion portions 131 (tooling component or tooling pin) can respectively pass through the first tooling hole 102 of the main board 10 to the second tooling hole 112 of the metal plate 11 so as to position relative positions of the lens set 13, the main board 10 and the metal plate 11. The two second protrusion portions 132 can respectively pass through the first screw holes 103 of the main board 10 to a surface of the metal plate 11 with the second screw holes 113. The second protrusion portions 132 and the second screw holes 113 can be respectively fastened by a screw component 16. In the embodiment, the screw component 16 can be preferably a screw. Those people having ordinary skill in the art should understand that the positioning embodiment of the tooling component and the embodiment the screw component are not limited to the foregoing description while in actual implementation.

The image sensing face 121 of the photosensitive element 12 of the image capturing device 1 can be vertical to the optical axis 133 of the lens set 13 so that the image quality is increased. In addition, a side of the lens set 13 is fastened by another screw component 17 (in the embodiment, the screw component 17 can be preferably a screw) on a camera frame 14 to complete the installation of the image capturing device 1 of the invention.

People having ordinary skill in the art should understand that the embodiment of the foregoing tooling holes, screw holes, tooling components, screw components and the lens set fastened to the camera frame are only examples instead of limitation while actually implementing the invention.

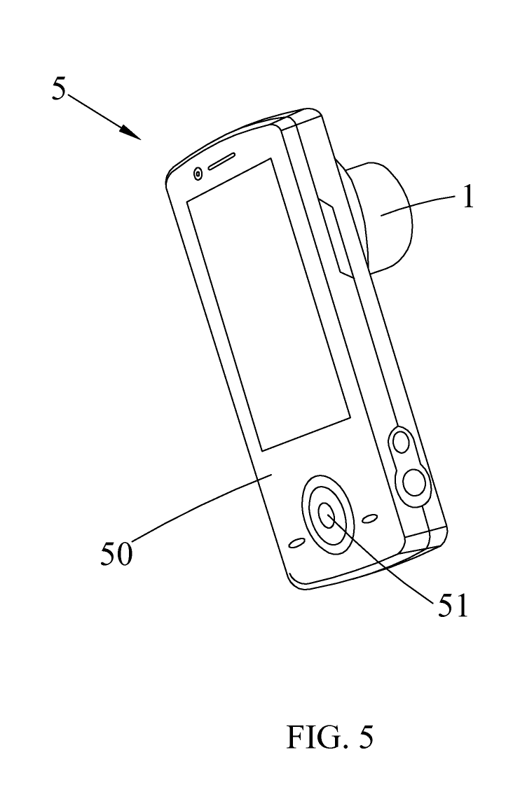

With reference to FIG. 5 for a schematic diagram of an electronic device having image capturing function in accordance with an embodiment of the invention is depicted. The electronic device 5 comprises a main body 50, an input device 51 and an image capturing device 1. The image capturing device 1 is disposed to the main body 50 and electrically connected to the input device 51. The image capturing device 1 comprises the main board, the metal plate, the photosensitive element, the lens set, the frame and related modules required for image capturing. The detail description of the image capturing device 1 herein has been depicted and there is no need to describe herein. It should be noted that the electronic device 5 of the invention can be different kinds of portable hand-held devices such as the digital camera, a multimedia player having photographing function, the mobile phone having photographing function, the Smartphone, a navigator, a tablet computer having photographing function or a personal digital assistant. The camera phone disclosed by the embodiment is only an example instead of limitation. People having ordinary skill in the art can easily replace the camera phone with other devices to incorporate the image capturing device of the invention into.

Although the concept of the assembly method for image capturing device of the invention has been simultaneously depicted in the process of illustrating the image capturing device, another flowchart is provided to clearly clarify.

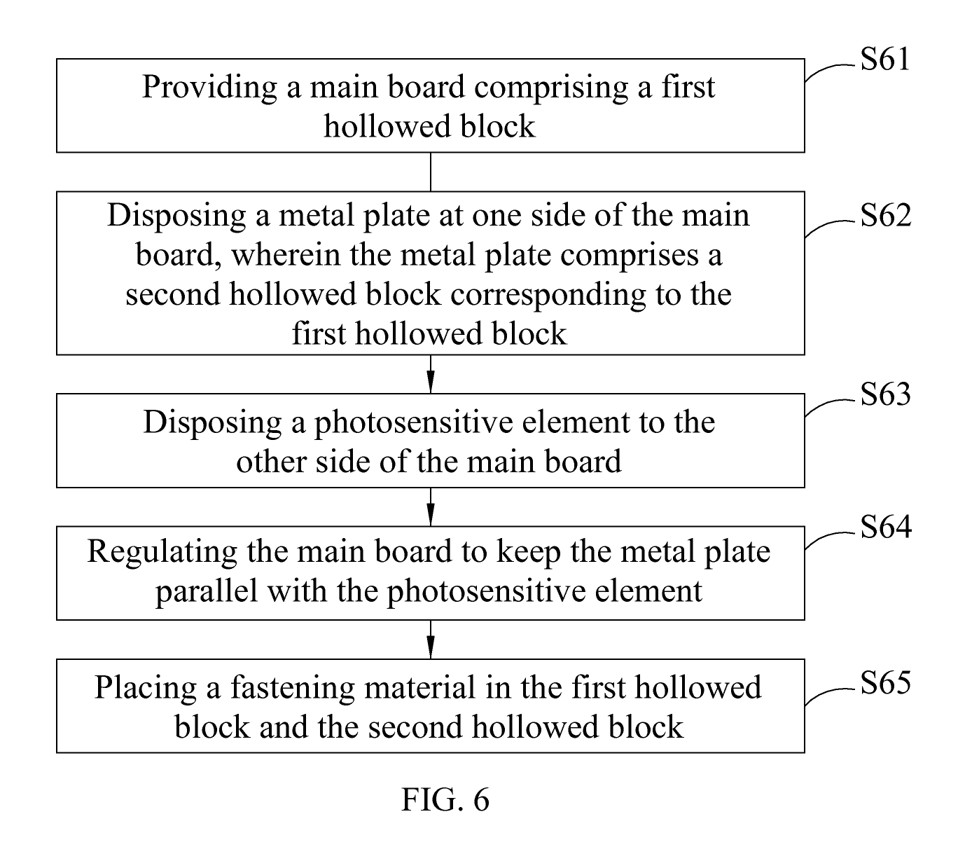

With reference to FIG. 6 for a flowchart of an assembly method for image capturing device is depicted. The assembly method for image capturing device comprises the following steps:

Step S61: providing a main board comprising a first hollowed block;

Step S62: disposing a metal plate at one side of the main board, wherein the metal plate comprises a second hollowed block corresponding to the first hollowed block;

Step S63: disposing a photosensitive element to the other side of the main board;

Step S64: regulating the main board to keep the metal plate parallel with the photosensitive element;

Step S65: placing a fastening material in the first hollowed block and the second hollowed block.

The detail depiction and embodiments of the assembly method for image capturing device of the invention have been illustrated in the prior description of the image capturing device and the electronic device, and there is no need to describe herein.

The image capturing device and the assembly method of the invention can fasten relative relationships among the photosensitive element, the main board and the metal plate through the UV glue after positioning them through jigs. The complicated process of aligning between the image photosensitive element and the lens set can be further reduced. In addition, the image sensing face of the photosensitive element is vertical to the optical axis of the lens set to further improve the quality of captured images.

The invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. An image capturing device comprising:
a main board comprising a first hollowed block;
a metal plate comprising a second hollowed block corresponding to the first hollowed block and disposed to one side of the main board; and
a photosensitive element disposed to the other side of the main board;
wherein the metal plate and the photosensitive element are parallel to each other, and the first hollowed block and the second hollowed block are filled with a fastening material.

2. The image capturing device as recited in claim 1, wherein the main board further comprises at least a first tooling hole, and the metal plate further comprises at least a second tooling hole, each second tooling hole is corresponding to each first tooling hole, and each first tooling hole and the second tooling corresponding to each first tooling hole are positioned by a screw component.

3. The image capturing device as recited in claim 1, wherein the main board comprises at least one first screw hole, and the metal plate further comprises at least a second screw hole, each second screw hole is corresponding to each first screw hole.

4. The image capturing device as recited in claim 1, further comprising a lens set, wherein the lens set and the photosensitive element are disposed on the same side of the main board, and an image sensing face of the photosensitive element is vertical to an optical axis of the lens set.

5. The image capturing device as recited in claim 4, further comprising a frame, wherein the frame and the lens set are mutually screwed by a screw component.

6. The image capturing device as recited in claim 1, wherein the fastening material comprises an UV glue.

7. An assembly method for an image capturing device comprises following steps:
providing a main board comprising a first hollowed block;
disposing a metal plate at one side of the main board, the metal plate comprising a second hollowed block corresponding to the first hollowed block;
disposing a photosensitive element at the other side of the main board;
regulating the main board to keep the metal plate parallel with the photosensitive element; and
placing a fastening material in the first hollowed block and the second hollowed block.

8. The assembly method for an image capturing device as recited in claim 7, further comprising following steps:
screwing at least a first screw hole of the main board and at least a second screw hole of the metal plate through at least a screw component, wherein each second screw hole is corresponding to each first screw hole.

9. The assembly method for an image capturing device as recited in claim 7, further comprising following steps:
disposing a lens set at a side of the main board, wherein the lens set and the photosensitive element are on the same side and an image sensing face of the photosensitive element is vertical to an optical axis of the lens set.

10. The assembly method for an image capturing device as recited in claim 9, further comprising following steps:
fastening a frame and the lens set through a fastening component.

11. An image capturing device comprising:
a main board comprising at least a first tooling hole;
a metal plate comprising at least a second tooling hole and disposed to one side of the main board, wherein each second tooling hole is corresponding to each first tooling hole; and
a photosensitive element disposed to the other side of the main board;
wherein the metal plate and the photosensitive element are parallel to each other, and each first tooling hole and the second tooling hole corresponding to each first tooling hole are positioned by a tooling component.

12. The image capturing device as recited in claim 11, wherein the main board further comprises a first hollowed block, and the metal plate further comprises a second hollowed block corresponding to the first hollowed block, and the first hollowed block and the second hollowed block are filled with a fastening material.

13. The image capturing device as recited in claim 12, wherein the fastening material comprises an UV glue.

14. The image capturing device as recited in claim 11, further comprising a lens set, wherein the lens set and the photosensitive element are disposed on the same side of the main board, and an image sensing face of the photosensitive element is vertical to an optical axis of the lens set.
